(19) United States
(12) Patent Application Publication
(10) Pub. No.: US 2021/0174352 A1
(43) Pub. Date: Jun. 10, 2021

(54) MINI-VAULTS FOR SECURING ACCOUNT INFORMATION

(71) Applicant: Capital One Services, LLC, McLean, VA (US)

(72) Inventors: Ni Kenney, Glen Allen, VA (US); Andrew Kenney, Glen Allen, VA (US)

(21) Appl. No.: 16/702,846

(22) Filed: Dec. 4, 2019

(51) Int. Cl. G06Q 20/38; G06Q 20/10; G06Q 20/40; G06Q 20/28; G06Q 20/32

(52) U.S. Cl. CPC G06Q 20/381; G06Q 20/108; G06Q 20/3224; G06Q 20/28; G06Q 20/40145

(57) ABSTRACT

Systems and methods disclosed herein describe techniques for securing a user's primary account information by providing a mini-vault for transactions. A mini-vault may be generated and associated with specific transactions. For instance, the mini-vault may be affiliated with a payee such that the payee may obtain funds from the mini-vault. Alternatively, the mini-vault may be associated with geographic and/or time-based restrictions. These may limit where and when the user may obtain the funds maintained in the mini-vault. Accordingly, the mini-vault may limit the exposure of primary account information to prevent a bad actor from accessing the funds maintained in a user's primary account.

### FIELD OF USE

Aspects of the disclosure relate generally to securing transactions and more specifically to using secondary accounts, or mini-vaults, to obfuscate primary account information.

### BACKGROUND

Credit and debit card transactions are a daily occurrence. People swipe their cards to make purchases and enter their account numbers into websites to make purchases and set up recurring bill payments. In some instances, merchants may store account information to allow a customer to make purchases quicker, simpler, and more convenient. However, the account information can fall into the hands of a bad actor when the merchant is breached. The bad actor may then use the account information to make fraudulent purchases and withdraw money from the user's account.

Aspects described herein may address these and other problems, and generally improve the quality, efficiency, and security related to online transactions and recurring payments.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

Systems and methods disclosed herein describe techniques for securing a user's primary account information by providing a secondary account, or a mini-vault. According to one aspect of the disclosure, a user may request that a secondary account be generated and affiliated with a payee. The secondary account may maintain a zero balance, except for when payment is to be remitted to the payee. Accordingly, the payment amount may be transferred from a primary account to the secondary account affiliated with the payee. The payment may then be pushed to the payee. The secondary account may obfuscate the primary account information and prevent a bad actor from obtaining the user's money.

According to another aspect of the disclosure, a user may request that a secondary account be generated to purchase foreign currency. The secondary account may include restrictions, such as geographic and time-based restrictions, that limit where and when the user may access the account. The secondary account may allow users to capitalize on low exchange rates and purchase foreign currency in advance of travelling abroad. Furthermore, the restrictions placed on the secondary accounts may ensure that malicious users and bad actors cannot obtain the foreign currency, thereby improving account security while travelling abroad.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 shows an example of a control processing system in which one or more aspects described herein may be implemented;

FIG. 2 shows an example computing device in accordance with one or more aspects described herein;

FIG. 3 shows a flow chart of a process for generating a secondary account according to one or more aspects of the disclosure;

FIG. 4 shows an example of a logical implementation of a plurality of secondary accounts affiliated with a plurality of payees in accordance with one or more aspects of the disclosure;

FIG. 5 shows a flow chart of a process for remitting payment to a payee according to one or more aspects of the disclosure;

FIGS. 6A-6E show an example of a user approving payment to a payee according to one or more aspects of the disclosure;

FIG. 7 shows a flow chart of a process for a merchant to obtain a token from an account holder according to one or more aspects of the disclosure;

FIG. 8 shows a flow chart of a process for generating a secondary account according to another aspect of the disclosure;

FIGS. 9A-9C show an example of a user approving purchase of a foreign currency according to one or more aspects of the disclosure; and

FIG. 10 shows a flow chart of a process for accessing a secondary account according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, aspects discussed herein may relate to methods and techniques for securing a user's primary account information by providing a secondary account, or a mini-vault, associated with a payee. Alternatively, the secondary account may be associated with user-defined restrictions, such as geographic restrictions, that may need to be satisfied prior to accessing the funds contained in the secondary account. Accordingly, a malicious user would be unable to gain access to the funds in a primary account if the information associated with the secondary account were compromised via a data breach.

Systems as described herein may include using secondary accounts, or mini-vaults to secure and obfuscate primary account information during transactions.

In order to secure their primary account, a user may request that a secondary account be generated and affiliated with a payee. In some embodiments, the secondary account may maintain a zero balance, except for when payment is to be remitted to the payee. Accordingly, a server may transfer the payment amount from a primary account to the secondary account affiliated with the payee. In some examples, the server may push the payment amount to the payee. Alternatively, the payee may pull the payment amount from the secondary account. Accordingly, the secondary account may obfuscate the primary account information. Furthermore, a bad actor may not obtain funds from the secondary account, if the secondary account information were to be compromised, since the secondary account typically maintains a zero balance.

In another embodiment, a user may request that a secondary account be generated to purchase foreign currency. The secondary account may include restrictions, such as geographic and time-based restrictions, that limit where and when the user may access the account. The secondary account may allow users to capitalize on low exchange rates and purchase foreign currency in advance of travelling abroad. Furthermore, the unconventional use of secondary accounts and the restrictions placed thereon may ensure that malicious users and bad actors cannot obtain the foreign currency, thereby improving the security of the user's account information while travelling abroad.

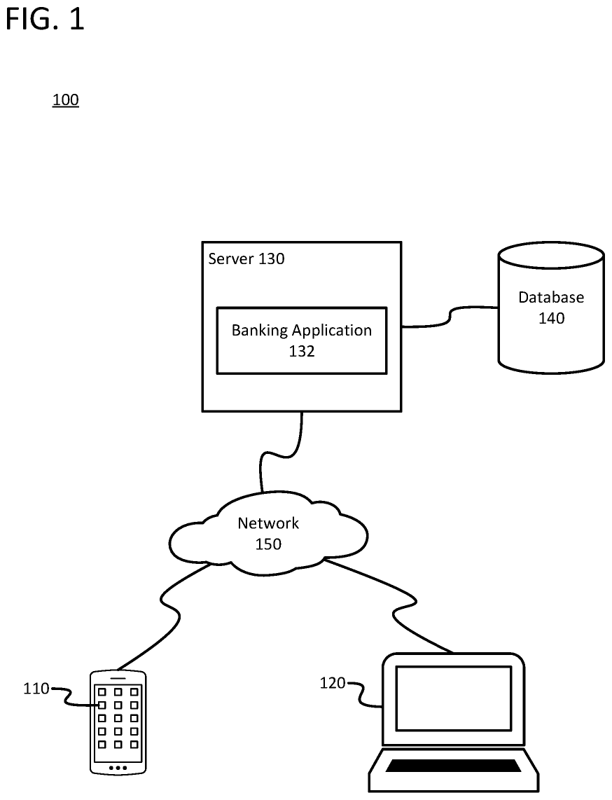

Turning to FIG. 1, a system 100 is shown that includes a first user device 110, a second user device 120, and a server 130, connected to a first database 140, interconnected via network 150.

First user device 110 may be a mobile device, such as a cellular phone, a mobile phone, a smart phone, a tablet, or a laptop. First user device 110 may provide a first user with access to various applications and services. For example, first user device 110 may provide the first user with access to the Internet. Additionally, first user device 110 may provide the first user with one or more applications (“apps”) located thereon. The one or more applications may provide the first user with a plurality of tools and access to a variety of services. In some embodiments, the one or more applications may include a banking application that provides access to the first user's banking information, as well as perform routine banking functions, such as checking the first user's balance, paying bills, transferring money between accounts, withdrawing money from an automated teller machine (ATM), and wire transfers. Additionally, the banking application may allow a user to set up one or more secondary accounts, each associated with a payee, to obfuscate information that would allow a malicious user to access the funds in a primary account.

Second user device 120 may be a computing device configured to allow a user to execute software for a variety of purposes. Second user device 120 may belong to the first user that accesses first user device 110, or, alternatively, second user device 120 may belong to a second user, different from the first user. Second user device 120 may be a desktop computer, laptop computer, or, alternatively, a virtual computer. The software of second user device 120 may include one or more web browsers that provide access to websites on the Internet. These websites may include banking websites that allow the user to access his/her banking information and perform routine banking functions. In some embodiments, second user device 120 may include a banking application that allows the user to access his/her banking information and perform routine banking functions. Additionally, or alternatively, the banking application may allow a user to set up one or more secondary accounts, each associated with a payee, to obfuscate information that would allow a malicious user to access the funds in a primary account.

Server 130 may be any server capable of executing banking application 132. Additionally, server 130 may be communicatively coupled to first database 140. In this regard, server 130 may be a stand-alone server, a corporate server, or a server located in a server farm or cloud-computer environment. According to some examples, server 130 may be a virtual server hosted on hardware capable of supporting a plurality of virtual servers.

Banking application 132 may be server-based software configured to provide users with access to their account information and perform routine banking functions. In some embodiments, banking application 132 may be the server-based software that corresponds to the client-based software executing on first user device 110 and second user device 120. Additionally, or alternatively, banking application 132 may provide users access to their account information through a website accessed by first user device 110 or second user device 120 via network 160. In this regard, banking application may manage a user's primary account (e.g., checking, savings, money market, etc.) and one or more secondary accounts. In some embodiments, each of the one or more secondary accounts may be affiliated with a payee and conduct transactions with the payee on behalf of the user (e.g. the primary account).

First database 140 may be configured to store information on behalf of application 132. The information may include, but is not limited to, personal information, account information, and user-preferences. Personal information may include a user's name, address, phone number (e.g., mobile number, home number, business number, etc.), social security number, username, password, employment information, family information, and any other information that may be used to identify the first user. Account information may include account balances, bill pay information, direct deposit information, wire transfer information, statements, and the like. User-preferences may define how users receive notifications and alerts, spending notifications, and the like. First database 140 may include, but are not limited to relational databases, hierarchical databases, distributed databases, in-memory databases, flat file databases, XML databases, NoSQL databases, graph databases, and/or a combination thereof.

First network 150 may include any type of network. In this regard, first network 150 may include the Internet, a local area network (LAN), a wide area network (WAN), a wireless telecommunications network, and/or any other communication network or combination thereof. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. The data transferred to and from various computing devices in system 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in system 100 in front of one or more computing devices such that any external devices may communicate directly with the specialized hardware.

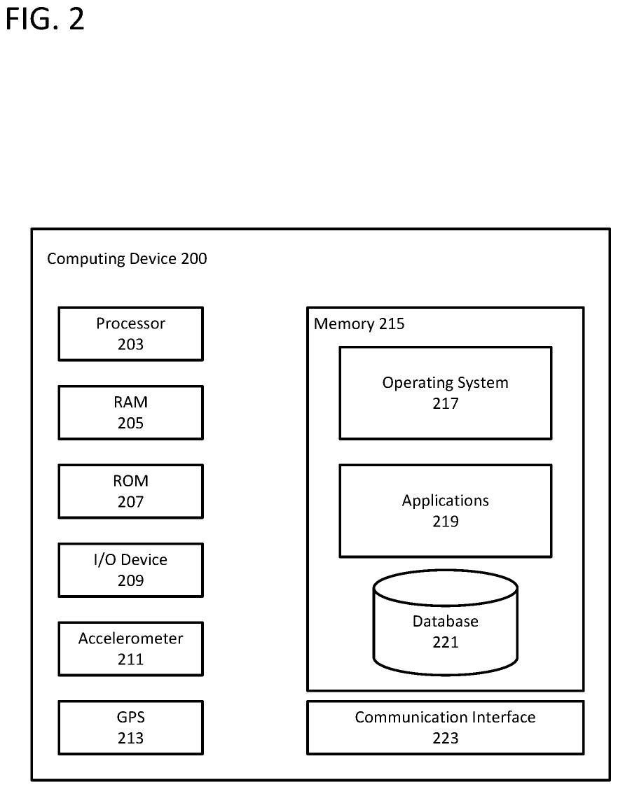

Any of the devices and systems described herein may be implemented, in whole or in part, using one or more computing systems described with respect to FIG. 2. Turning now to FIG. 2, a computing device 200 that may be used with one or more of the computational systems is described. The computing device 200 may include a processor 203 for controlling overall operation of the computing device 200 and its associated components, including RAM 205, ROM 207, input/output device 209, accelerometer 211, global-position system antenna 213, memory 215, and/or communication interface 223. A data bus may interconnect processor(s) 203, RAM 205, ROM 207, memory 215, I/O device 209, accelerometer 211, global-position system receiver/antenna 213, memory 215, and/or communication interface 223. In some embodiments, computing device 200 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 209 may include a microphone, keypad, touch screen, and/or stylus through which a user of the computing device 200 may provide input, and may also include one or more of a speaker for providing audio output and a video display device for providing textual, audiovisual, and/or graphical output. Software may be stored within memory 215 to provide instructions to processor 203 allowing computing device 200 to perform various actions. For example, memory 215 may store software used by the computing device 200, such as an operating system 217, application programs 219, and/or an associated internal database 221. The various hardware memory units in memory 215 may include volatile and nonvolatile, removable and non-removable media implemented in any method or technology for storage of information such as computer-readable instructions, data structures, program modules, or other data. Memory 215 may include one or more physical persistent memory devices and/or one or more non-persistent memory devices. Memory 215 may include, but is not limited to, random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 203.

Accelerometer 211 may be a sensor configured to measure accelerating forces of computing device 200. Accelerometer 211 may be an electromechanical device. Accelerometer may be used to measure the tilting motion and/or orientation computing device 200, movement of computing device 200, and/or vibrations of computing device 200. The acceleration forces may be transmitted to the processor to process the acceleration forces and determine the state of computing device 200.

GPS receiver/antenna 213 may be configured to receive one or more signals from one or more global positioning satellites to determine a geographic location of computing device 200. The geographic location provided by GPS receiver/antenna 213 may be used for navigation, tracking, and positioning applications. In this regard, the geographic may also include places and routes frequented by the first user. In the context of a banking application, GPS receiver/antenna 213 may be used to locate one or more banking locations.

Communication interface 223 may include one or more transceivers, digital signal processors, and/or additional circuitry and software for communicating via any network, wired or wireless, using any protocol as described herein.

Processor 203 may include a single central processing unit (CPU), which may be a single-core or multi-core processor, or may include multiple CPUs. Processor(s) 203 and associated components may allow the computing device 200 to execute a series of computer-readable instructions to perform some or all of the processes described herein. Although not shown in FIG. 2, various elements within memory 215 or other components in computing device 200, may include one or more caches, for example, CPU caches used by the processor 203, page caches used by the operating system 217, disk caches of a hard drive, and/or database caches used to cache content from database 221. For embodiments including a CPU cache, the CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 205 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the invention.

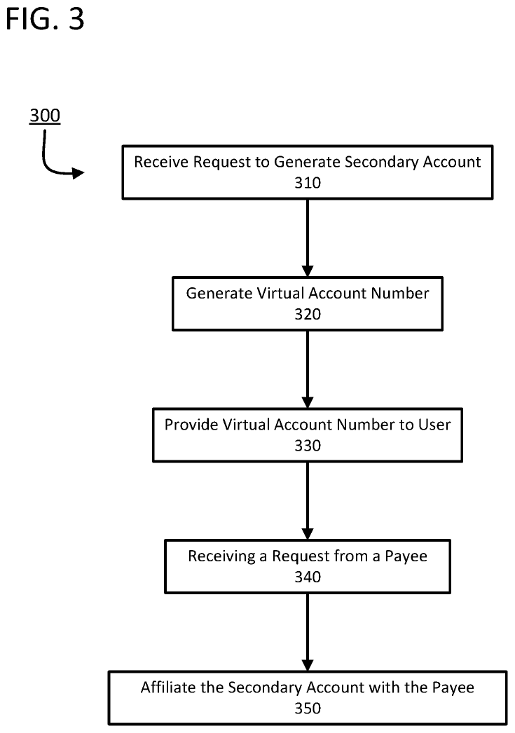

In order to secure their primary account, a user may request that a secondary account be generated and affiliated with a payee. FIG. 3 shows a flow chart of a process for generating a secondary account according to one or more aspects of the disclosure. Some or all of the steps of process 300 may be performed using one or more computing devices as described herein.

In step 310, a server, for example server 130 executing banking application 132, may receive a request, from a user, to generate a secondary account. The request may be received via mobile application, executing on a user's mobile device, or via a web interface. The request may include payee information. For example, the user may define that the secondary account is affiliated with a payee, such as a merchant, a social network, a payment service, a retirement account, a stock exchange, a cryptocurrency exchange, or an equivalent thereof. Alternatively, payee information may be affiliated with the secondary account after the secondary account is generated. Alternatively, the request may come directly from the payee on behalf of the user, in which case, authorization from the user may be obtained prior to generating a secondary account number.

In step 320, the server may generate a virtual account number for the secondary account. The virtual account number may be a pseudorandom string of characters generated using a pseudorandom number generator. Alternatively, the virtual account number may be a virtual card number. For example, the virtual card number may be limited to 16 digits. In yet another alternative, the virtual account number may be a token generated by performing a mathematical operation (e.g., a hash function) on the user's primary account information and/or user information, such as the user's social security number, address, age, credit score, average account balance, etc.

In step 330, the virtual account number may be provided to the user and/or the payee. The virtual account number may be displayed to the user via the mobile application interface or the web interface. Alternatively, or additionally, the virtual account number may be provided to the user via an encrypted channel, such as an encrypted email or an encrypted message. After obtaining the virtual account number, the user may use the virtual account number to make payments to a payee.

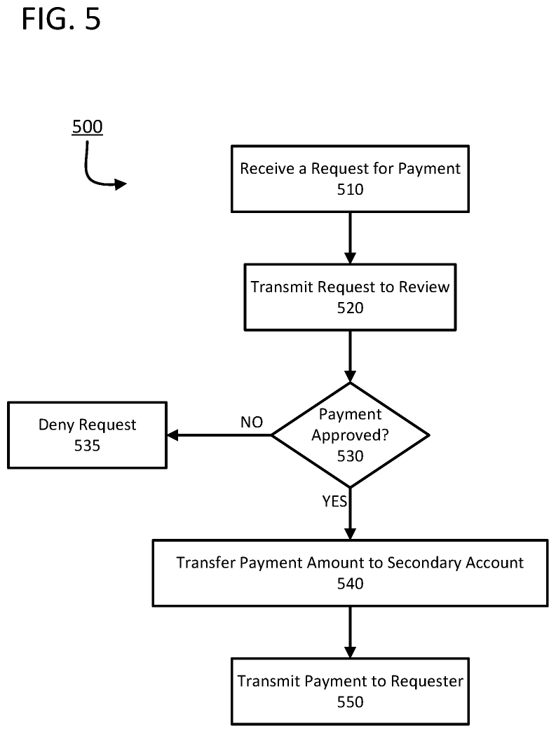

In step 340, the server may receive a payment request from a payee. The payment request may include the virtual account number provided to the user. As will be described in greater detail below with respect to FIG. 5, the server application may request approval from the user before remitting payment to the payee. In step 350, the server may affiliate, or associate, the secondary account with the payee. As discussed above, a user may configure the secondary account to be affiliated with the payee. In these embodiments, step 350 may be skipped. Alternatively, or additionally, the server may confirm that the payee is affiliated with the secondary account in step 350.

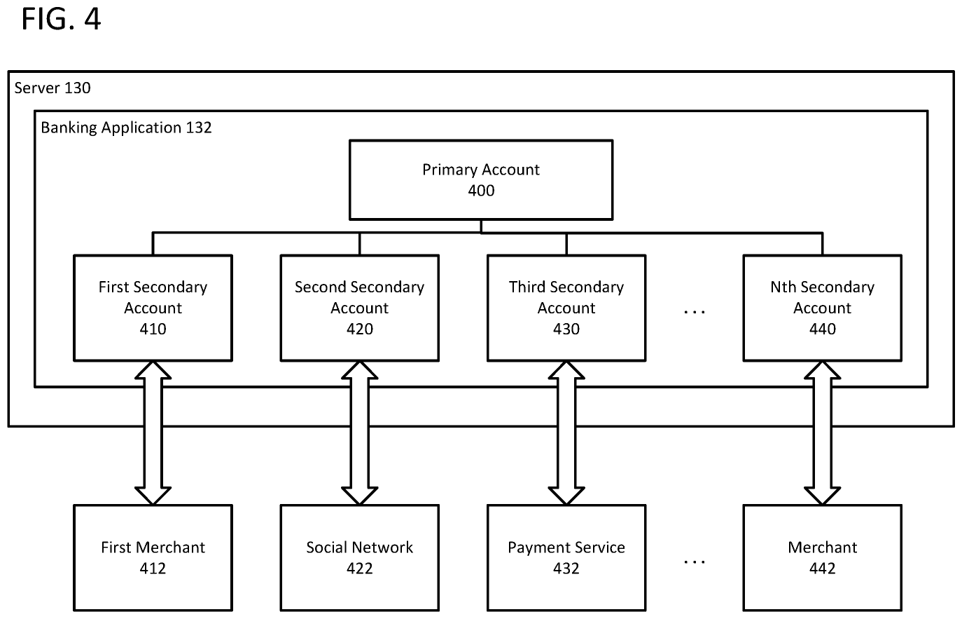

Process 300 may be repeated for one or more payees. Accordingly, each payee may be affiliated with a separate secondary account. FIG. 4 shows an example of a logical implementation of a plurality of secondary accounts affiliated with a plurality of payees in accordance with one or more aspects of the disclosure.

FIG. 4 illustrates first server 130 and banking application 132. Banking application 132 may include a primary account 400 and a plurality of secondary accounts (e.g., a first secondary account 410, a second secondary account 420, a third secondary account 430, and n^{th} secondary account 440). Each of the plurality of secondary accounts may be linked to a payee. For example, the first secondary account 410 may be linked to a first merchant 412, the second secondary account 420 may be linked to a social network 422 (e.g., Facebook®), the third secondary account 430 may be linked to a payment service 432 (e.g., PayPal®, Venmo®), and the nth secondary account 440 may be linked to merchant 442. The primary account 400 may be any suitable banking account, such as a savings account, a checking account, a money market account, or any equivalent thereof. The plurality of secondary accounts may be mini-vaults. As used herein, mini-vaults may be accounts used to obfuscate primary account information (e.g., routing number, account number) and conduct transactions (e.g., remit payments) with an affiliated payee. In this regard, secondary accounts may behave similarly to a checking account. Secondary accounts and mini-vaults may be used interchangeably. In operation, the plurality of secondary accounts may maintain a zero, or near zero, balance. In this regard, “near zero” may be understood as a balance of a few cents (e.g., when a few cents are deposited to verify an account). As will be discussed in greater detail below with respect to FIG. 5, the server 130 (e.g., banking application 132 executing on server 130) may transfer a payment amount from the primary account 400 to the secondary account affiliated with a payee. The server 130 (e.g., banking application 132) may remit payment from the secondary account to the linked payee.

In order to remit payment to a payee, a request for payment may first be received from a payee. A user may schedule the payment based on receiving the request for payment. Alternatively, or additionally, a user may approve payment and the banking application may process the transaction. FIG. 5 shows a flow chart of a process for remitting payment to a payee according to one or more aspects of the disclosure. Some or all of the steps of process 500 may be performed using one or more computing devices as described herein.

Process 500 begins, in step 510, with receiving a request for payment. The request for payment may be received by server 130. Alternatively, or additionally, a user may receive the request for payment. In some instances, the user may receive the request for payment via server 130. The request for payment may be a bill, a recurring payment (e.g. a subscription service), an automatic withdrawal, or any equivalent thereof.

In step 520, a request to review the received payment request may be transmitted to a user. The server 130 (e.g., banking application 132) may transmit a request to review the received payment request to a user. The request may be an electronic notification provided, for example, via email, text message, push notification, an electronic communication through a banking application, an electronic communication via a web interface, or any equivalent thereof. In some embodiments, the electronic notification may include an option where the user may approve or deny the payment request. Alternatively, or additionally, the electronic notification may include a link to access either an application (e.g., mobile application) or web interface to review the payment request. The user may then approve or deny the payment request through the application or the web interface. Alternatively, the user may set parameters to automatically fund specific mini-vaults on specific days for specific amounts and not require verification if a payee makes a request for a specific amount on a specific date (e.g., a subscription service).

In step 530, server 130 may determine whether payment has been approved by the user. As discussed above, this may include an indication from the user that the payment is approved. In some embodiments, the approval process may include authentication of the user. For example, the user may have to provide a username and password when approving the transaction, which the server 130 may compared to a previously stored username and password. Alternatively, or additionally, server 130 may authenticate the user using a biometric identifier. For example, server 130 may authenticate the user using facial recognition, a fingerprint, a voiceprint, a retina scan, or any equivalent thereof. In some instances, server 130 may require multifactor authentication to approve the payment request. In this regard, the server 130 may authenticate a plurality of biometric identifiers associated with the user. Alternatively, or additionally, the server 130 may authenticate a biometric identifier and a password (e.g., one-time password). In further embodiments, a payment scheduled by the user, either through an application or a web interface, may be implicitly approved and may not require additional approval from the user. When the payment request is denied and/or the user is not authenticated, process 500 proceeds to step 535, where the payment request is denied. In some embodiments, server 130 may transmit a notification to the payment requester that the payment request has been denied. However, when the payment is approved, process 500 proceeds to step 540.

In step 540, server 130 may transfer the payment amount, from the primary account to a secondary account associated with the payment requester, for example, after or in response to the payment request being approved. In step 550, server 130 may transmit (e.g., send) the payment to the requester/payee. In some embodiments, server 130 may push the payment to the requester/payee. Accordingly, payment may be remitted to the payee in a secure fashion (e.g., over an encrypted channel), and the payee may obtain the secondary account information (e.g., routing number, account number) as part of the payment process. Because the secondary account maintains a zero, or near zero, balance, a bad actor may not be able to make any fraudulent purchases or draw down upon the user's balance with the secondary account information, thereby protecting the user's balance in primary account 400.

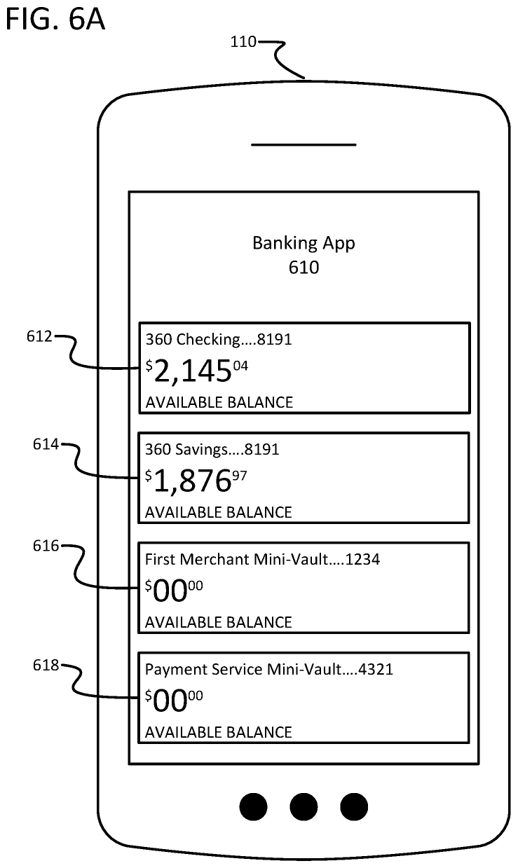

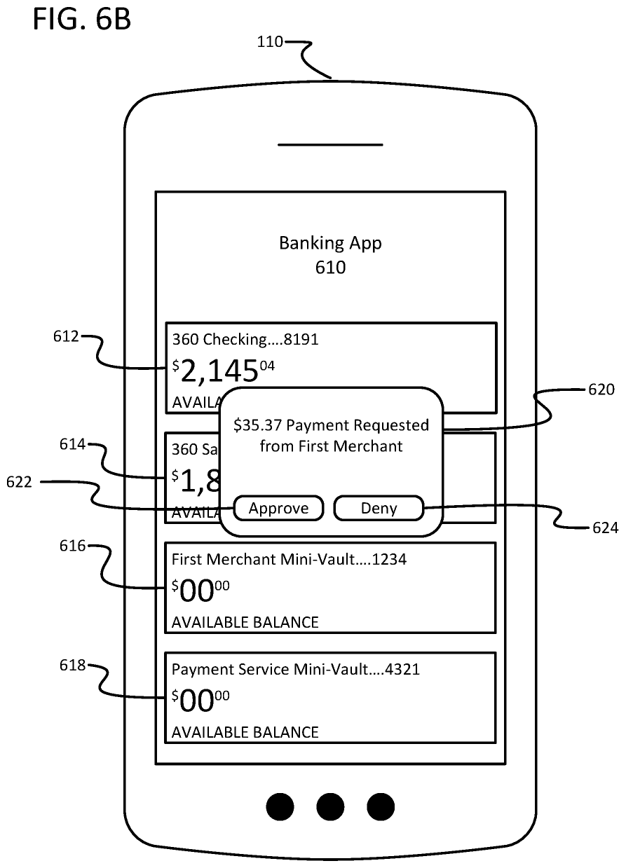

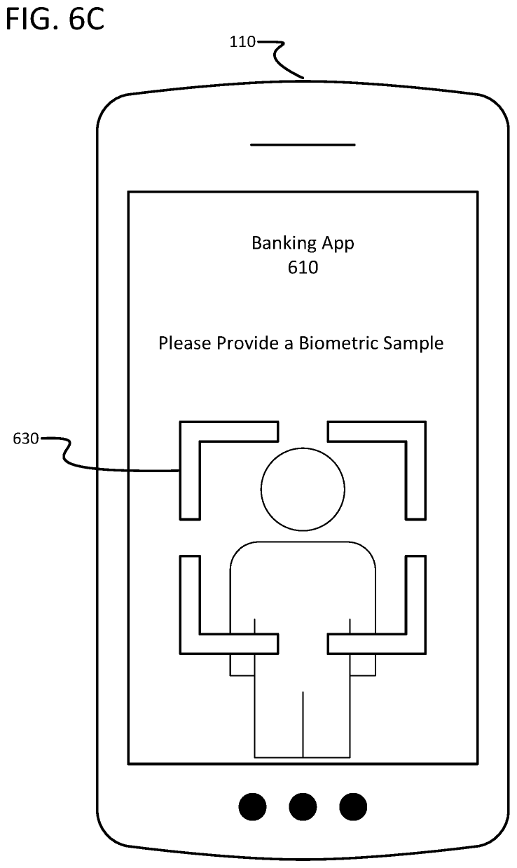

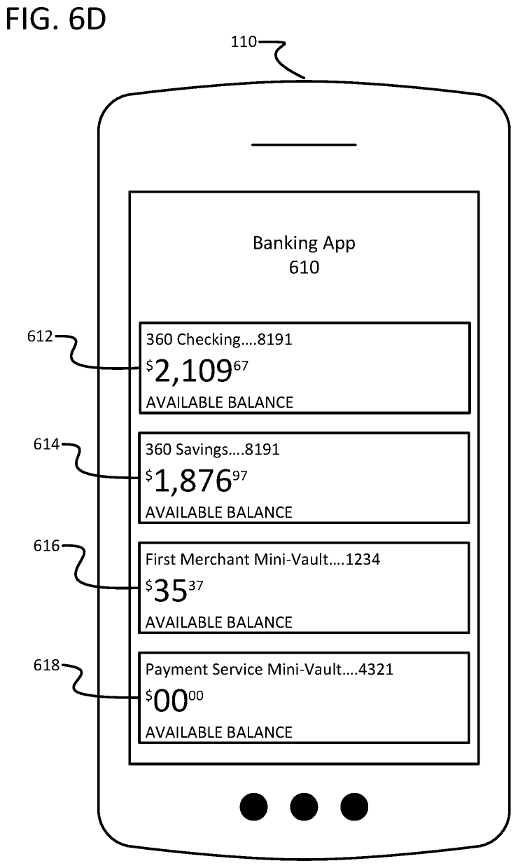

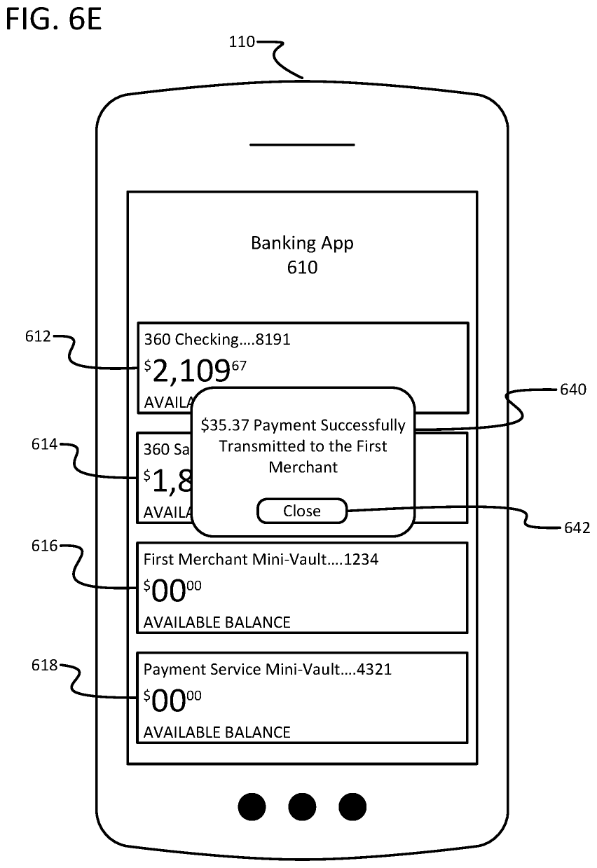

As discussed above, a user may provide approval as part of the payment process. FIGS. 6A-6E show an example of a user approving payment to a payee according to one or more aspects of the disclosure. FIG. 6A illustrates first user device 110. First user device 110 may be executing a banking application 610. Banking application 610 may provide a user with access to their various accounts, as well as additional functionality, such as, bill payment, wire transfers, etc. As illustrated in FIG. 6A, banking application 610 may display a first primary account 612, a second primary account 614, a first secondary account 616, and a second secondary account 618. The first primary account 612 may be a checking account and the second primary account 614 may be a savings account. Both the first primary account 612 and the second primary account 614 may contain balances. It will be appreciated that the first primary account 612 and the second primary account 614 are merely illustrative and the user may have more or fewer primary accounts of varying types. When a user has multiple primary accounts, the user may configure which primary account to transfer money from to remit payments to requesters/payees. The first secondary account 616 and the second secondary account 618 may be a first and second mini-vault, respectively. As shown, the first secondary account 616 may be affiliated with a first merchant, while the second secondary account 618 may be affiliated with a first payment service. It will be appreciated that the first secondary account 616 and the second secondary account 618 are merely illustrative and the user may have more or fewer secondary accounts, each affiliated with a different payee. In contrast to the first primary account 612 and the second primary account 614, the first secondary account 616 and the second secondary account 618 may maintain a zero, or near zero, balance (e.g., 0.00).

Turning to FIG. 6B, an example of receiving a request to review the received payment request is shown. Banking application 610 may display window 620, which may include a request to make a payment, in the amount of $35.37, to a first merchant. The window 620 may include an approve button 622 and a deny button 624. As discussed above, if the user selects the deny button 624, the request for payment may be denied and the server may transmit a notification to the requester that the payment request has been denied. However, if the user selects the approve button 622, banking application 610 may transition to an authentication screen. As noted above, the authentication screen may prompt the user for a username and password to confirm the payment. Alternatively, or additionally, the authentication screen may prompt the user to provide a biometric identifier for authentication purposes as shown in FIG. 6C.

FIG. 6C shows an example of banking application 610 prompting the user for a biometric sample. Banking application 610 may activate a forward facing camera on first user device 110 to obtain a picture of the user. The user may have to center their face in guidelines 630 to capture the picture. The picture may be automatically captured when the first user device is in a position relative to the user as indicated by the guidelines 630. After the picture is captured, the picture may be compared to an image on file with server 130 for authentication purposes. While image capture is shown in FIG. 6C, it will be appreciated that the user may be prompted for a different type of authentication, such as a fingerprint, a retina scan, a voiceprint, or the like. After the user been authenticated and provided their approval, the server 130 may transfer the payment amount (e.g. $35.37) from one of the primary accounts to the secondary account (e.g., mini-vault) affiliated with the requester/payee.

FIG. 6D shows an example of the payment amount transferred from a primary account to a secondary account affiliated with the requester/payee. As shown in FIG. 6D, the payment amount (e.g. $35.37) may be transferred from the first primary account 612 to the first secondary account 616. Once the payment amount has been transferred from the primary account to the secondary account, the server 130 may transfer the payment amount from the secondary account to the requester/payee.

FIG. 6E shows an example of the payment being transmitted successfully to the payee. Banking application 612 may display window 640, which indicates that the payment has been transmitted to the payee successfully. Window 640 may also include a close button 642 to close the window 640. FIG. 6E also reflects the payment amount deducted from the first primary account 612. Additionally, the first secondary account 616 may also reflect a zero, or near zero, balance.

As discussed above, conducting transactions using the techniques described herein prevents information (e.g., account number, routing information) associated with the primary account from being distributed to third parties. Instead, the secondary account information (e.g., account number), or tokenized secondary account information, may be provided to payees. This allows secure payments to be made to the payees without exposing primary account information (e.g., account number). Furthermore, bad actors and malicious users may not be able to make fraudulent charges or purchases or withdraw money even if the bad actors or malicious users were able to obtain the secondary account information. This is due, in part, to the authentication mechanisms described herein, in addition to the secondary account maintaining a zero, or near zero, balance.

In some instances, server 130, or the user, may receive requests for payment from requesters/payees that are not affiliated with a secondary account. In these cases, server 130 may prompt a user to create a secondary account for the requester/payee. The user may create the secondary account for the requester/payee using the techniques described above with respect to FIG. 3. Alternatively, the user may deny the request to create the secondary account affiliated with the requester/payee. In these instances, a secondary account may not be created for the requester/payee, and payment may be remitted from one of the user's primary accounts. The authentication techniques described above with respect to FIGS. 5 and 6 may be performed to authenticate the payer before transmitting payment to the requester/payee.

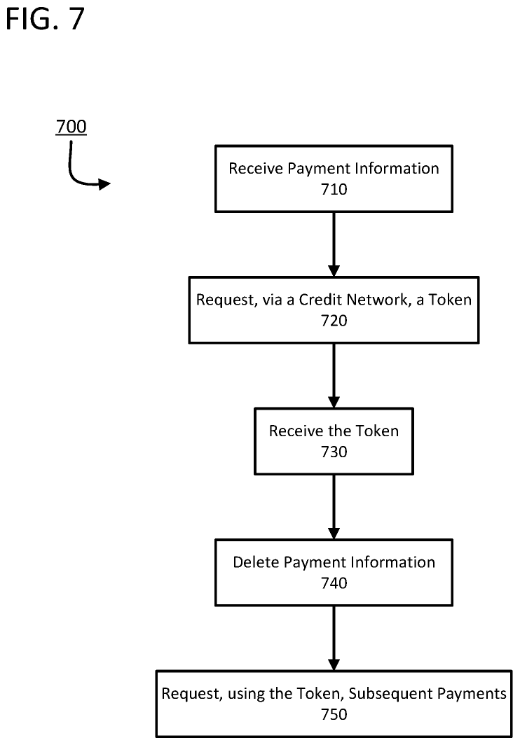

According to some embodiments, a user may create a secondary account for recurring payments, such as a monthly subscription service (e.g., Netflix®). FIG. 7 shows a flow chart of a process for a merchant to obtain a token from an account holder according to one or more aspects of the disclosure. Some or all of the steps of process 700 may be performed using one or more computing devices as described herein.

Process 700 may begin, at step 710, with a payee receiving payment information from a user. As described above, the payee may be a merchant, a social network, a payment service, a subscription service, or any equivalent thereof. The payment information may include a transaction card number (e.g., credit card number or debit card number), account information (e.g., account number and routing number), or any equivalent thereof.

In step 720, the payee may transmit a request to a credit network for a token. The request may include information to identify the payer and their respective account information. In some instances, the request may include the account information. The credit network may be an interbank network that interconnects a plurality of banking institutions. The credit network may route the request to the appropriate banking institution.

In step 730, the payee may receive the token from the banking institution associated with the payer. The token may include a virtual account number. Alternatively, the token may be generated by applying a mathematical operation (e.g. a hash function) to the user's primary account information and/or user information, such as the user's social security number, address, age, credit score, average account balance, etc. In step 740, the payee may delete the payment information received from the payer in step 710. Instead of the payment information provided by the user originally, the payee may store the token and use the token to make subsequent payment requests to the payee, via the payee's banking institution, in step 750. Payments may be made to the requesting party using the techniques described above with respect to FIGS. 5 and 6. Alternatively, the token may be used to pull payment from the user's account.

By replacing payment information with a token, the payee may be able to obtain payment on behalf of the payee without having to store sensitive user information. If the payee were to be breached, the payee could notify the banking institution, which may invalidate the token. Thus, a bad actor may not be able to draw down on the user's account, incur fraudulent charges, or make fraudulent purchases using the token.

In some embodiments, the user may provide the payee with a token initially. As discussed above, the token may be a virtual account number or a pseudorandom number generated from a plurality of user information. In these instances, the payee may not need to issue the token request to the credit network, and may, instead, use the token received from the payee to pull money from the payee's accounts for recurring payments.

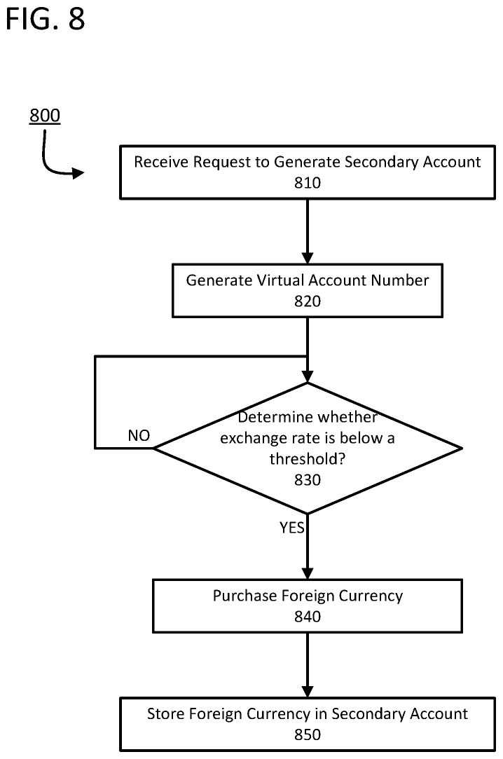

In order to secure their primary account while travelling overseas, a user may open a secondary account that may be affiliated with a foreign currency, geographic restrictions, and/or time-based restrictions. FIG. 8 shows a flow chart of a process for generating a secondary account according to one or more aspects of the disclosure. Some or all of the steps of process 800 may be performed using one or more computing devices as described herein.

In step 810, a server, for example server 130 executing banking application 132 executing on server 130, may receive a request, from a user, to generate a secondary account. The request may specify a currency for the secondary account, such as a foreign currency, like the Euro (€) or the Chinese Yuan (¥). Additionally, the request may define geographic restrictions on where the account may be accessed. The geographic restrictions may be to specific countries. In some instances, the geographic restrictions may define specific automated teller machines (ATMs) from which the user may withdraw money from. Alternatively, the geographic restrictions may use the location services of a user's device to verify that the user is proximate to the ATM. Additionally, or alternatively, the request may define a predetermined time period during which the account may be accessed. For example, a user may indicate that the secondary account may only be accessed from a Eurozone country or from mainland China. The request may also define time-based restrictions. For instance, the user may indicate that the secondary account may only be accessed during a certain time period, such as during the user's vacation. In this regard, the geographic and time-based restrictions may be used together or separately. In some embodiments, the request may also indicate an exchange rate threshold for which server 130 may purchase the foreign currency. For instance, a user may indicate that server 130 may purchase Euro when the exchange rate is equal to or lower than 1.20.

In step 820, the server may generate a virtual account number for the secondary account. The virtual account number may be a pseudorandom string of characters generated using a pseudorandom number generator, a virtual card number, or a token. Once the secondary account has been created, and the information of the secondary account provided to the user, the server may begin purchase foreign currency. In step 830, the server may determine whether the exchange rate is below the threshold set by the user. When the exchange rate is not below the threshold, the server may continue to monitor the exchange rate to determine whether the exchange rate has fallen below the threshold set by the user. However, when the exchange rate is below the threshold, the server may purchase the foreign currency in step 840. The purchase of foreign currency may require the user's approval. In this regard, the user authentication and/or approval techniques described above with respect to FIGS. 5 and 6 may be used prior to any purchase of the foreign currency. Once the foreign currency has been purchased, the foreign currency may be stored in the secondary account in step 850.

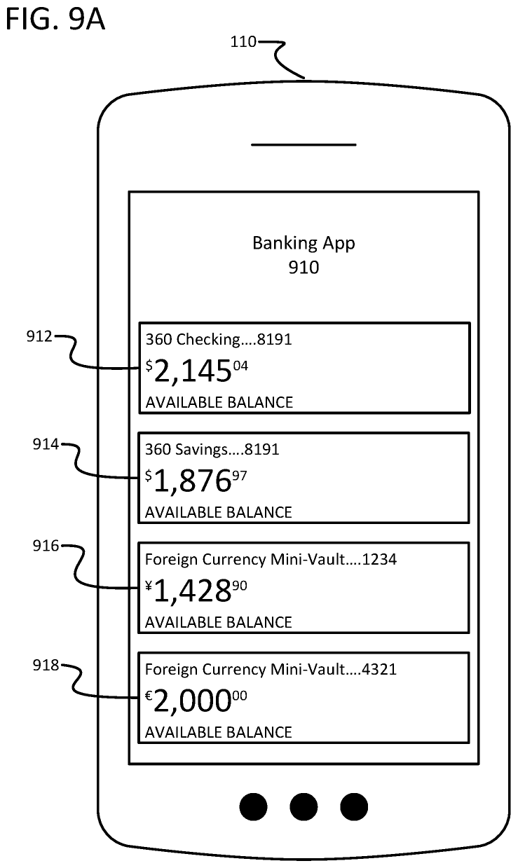

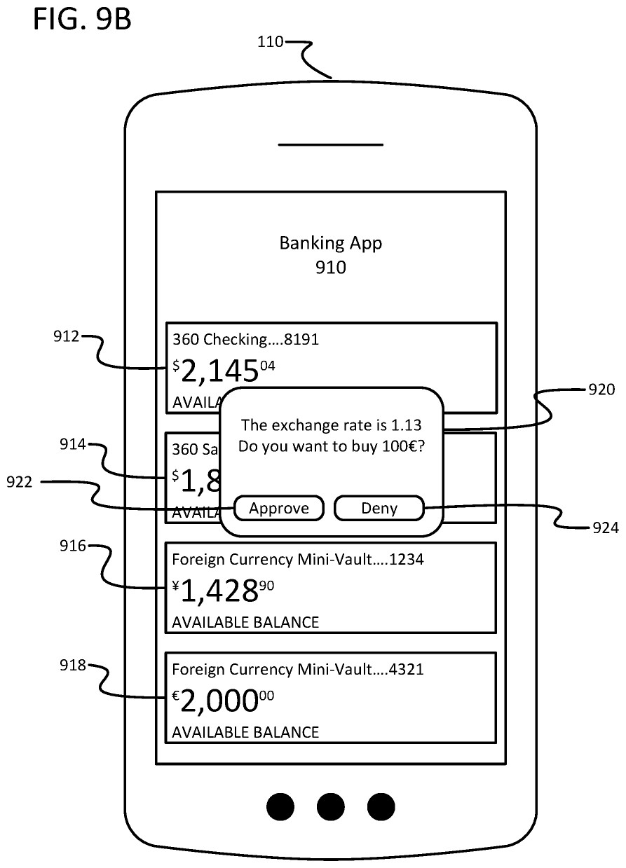

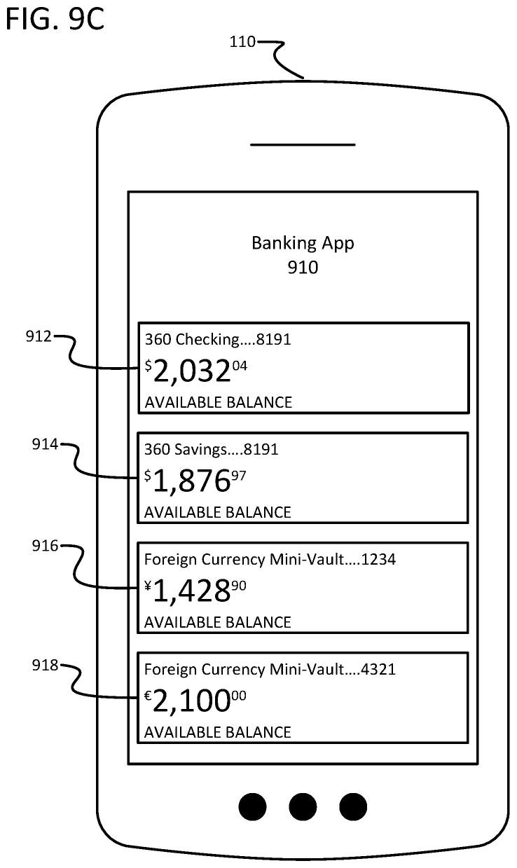

As discussed above, a user may provide approval as part of the foreign currency purchase. FIGS. 9A-9C show an example of a user approving purchase of a foreign currency according to one or more aspects of the disclosure. FIG. 9A illustrates first user device 110. First user device 110 may be executing a banking application 910. As shown in FIG. 9A, banking application 910 may display a first primary account 912, a second primary account 914, a first secondary account 916, and a second secondary account 918. The first primary account 912 and the second primary account 914 may be similar to the first primary account 612 and the second primary account 614 discussed above. The first secondary account 916 and the second secondary account 918 may be a first and second mini-vault, respectively. The first secondary account 916 may be a foreign currency mini-vault for Chinese Yuan, and the second secondary account 918 may be a foreign currency mini-vault for Euro. Unlike the secondary accounts discussed above, the first secondary account 916 and the second secondary account 918 may maintain a balance in a foreign currency.

Turning to FIG. 9B, an example of receiving a request to purchase foreign currency is shown. Banking application 910 may display window 920, which may display the exchange rate and inquire whether the user would like to purchase the foreign currency. The window 920 may include an approve button 922 and a deny button 924. If the user selects the deny button 924, the server may not purchase the foreign currency on behalf of the user. However, if the user selects the approve button 922, the server 130 may purchase the foreign currency on the user's behalf. As noted above, the server 130 may authenticate the user according to one or more authentication schemes before authorizing the purchase of the foreign transaction.

FIG. 9C shows an example of a successful foreign currency purchase. In this regard, banking application 910 may be updated to reflect the new balances. For example, first primary account 912 may have a lower balance, while second secondary account 918 may reflect a higher balance as a result of the foreign currency purchase. By purchasing foreign currency using the techniques described herein allows users to capitalize on low exchange rates and purchase foreign currency in advance of travelling abroad. The unconventional combination of secondary accounts and authentication measures ensure that malicious users and bad actors are prevented from obtaining the foreign currency, thereby improving the security of foreign currency when travelling abroad.

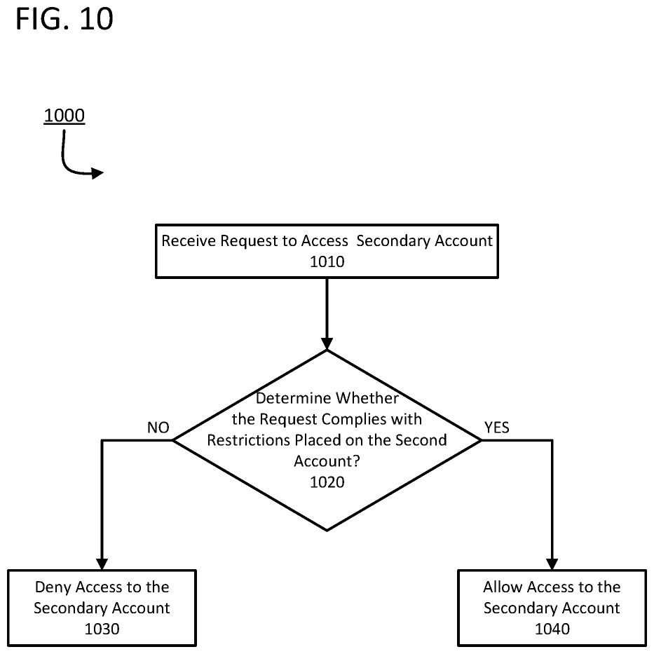

After purchasing the foreign currency, the user may travel internationally and access the secondary account. FIG. 10 shows a flow chart of a process for accessing a secondary account according to one or more aspects of the disclosure. Some or all of the steps of process 1000 may be performed using one or more computing devices as described herein.

Process 1000 begins at step 1010, with the server 130 receiving a request to access a secondary account. The request may be part of an automated teller machine (ATM) transaction. In particular, the user may be attempting to withdraw the foreign currency at an international ATM. Alternatively, the request may be made from an international bank or wire transfer service to access the foreign currency maintained in the secondary account. In step 1020, the server 1030 may determine whether the request to access the secondary account complies with the restrictions on the secondary account. For example, the server 130 may determine whether a location of the request is within the geographic restrictions set by the user. If the request does not comply with the restrictions placed on the secondary account, the server 130 may deny access to the secondary account in step 1030. However, if the request does comply with the restrictions placed on the secondary account, the server 130 may grant access to the secondary account in step 1040. For example, the server 130 may allow the user to withdraw a requested amount from the secondary account. In addition to capitalizing on better exchange rates and saving for foreign travel, the techniques described herein improve the security of accessing money by limiting the amount of funds a bad actor/malicious user may access if the user's debit card is lost or stolen while travelling internationally.

By taking advantage of the secondary accounts described herein, users may reduce their exposure to fraudulent bank activity. As discussed above, the secondary accounts obfuscate the primary account information. This may prevent bad actors from stealing the money contained in the primary account. Moreover, maintaining a low, or zero, balance and placing restrictions on when, where, and how users can access the secondary accounts ensures that de minimis damage occurs if the secondary account information were obtained by a bad actor or malicious users. Therefore, the techniques described herein improve banking security and reduce the likelihood of success of bad actors/malicious users making fraudulent charges and/or purchases.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1. A computer-implemented method comprising:
receiving, by a computing device and from a user device, a request to generate a mini-vault associated with a first account, wherein the request comprises:
a one-to-one affiliation between the mini-vault and one or more geographic restrictions on where the mini-vault can be accessed, and
one or more time periods during which the mini-vault may be accessed;
generating, by the computing device and in response to the request to generate the mini-vault, the mini-vault;
generating, by the computing device and in response to generating the mini-vault, a pseudorandom number by hashing information associated with the first account and user information;
assigning, by the computing device, the pseudorandom number to the mini-vault as an account number;
providing, by the computing device and to the user device, information associated with the mini-vault;
monitoring, by the computing device, an exchange rate between a first currency and a second currency;
determining, by the computing device, the exchange rate between the first currency and the second currency;
transmitting, by the computing device and to the user device, a request to purchase the second currency when the exchange rate is below a threshold, wherein the request to purchase the second currency is based on a future expense;
receiving, by the computing device and from the user device, a response to the request to purchase the second currency, wherein the response comprises an approval to purchase the second currency;
purchasing, by the computing device and based on the approval, the second currency using funds from the first account;
storing, by the computing device, the second currency in the mini-vault;
receiving, by the computing device from a merchant and via a secure communication channel, a request for payment in the second currency, wherein the request for payment comprises a payment amount and a location of the request for payment;
transmitting, by the computing device and to the user device, a request to review the request for payment received from the merchant;
receiving, by the computing device and from the user device, a response to the request to review the request for the payment, wherein the response comprises an approval of the payment amount to the merchant and a biometric identifier associated with a user of the user device;
verifying that the location of the request for payment is within the one or more geographic restrictions defined when the request to generate the mini-vault was received;
verifying that the request for payment is within the one or more time periods during which the mini-vault may be accessed;
verifying the biometric identifier by comparing the biometric identifier to a stored biometric identifier to authenticate the user; and
transmitting, via the secure communication channel and based on the approval, verification of the location of the request for payment, verification of the request for payment is within the one or more time periods, and verification of the biometric identifier, the payment amount from the mini-vault, wherein the mini-vault obfuscates information associated with the first account.

2. The computer-implemented method of claim 1, wherein the response further comprises a one-time password.

3. (canceled)

4. The computer-implemented method of claim 1, further comprising:
determining, using location services of the user device, a location of the user device;
determining whether the request for payment is located proximate to the location of the user device; and
verifying the request for payment when the location of the user device is located proximate to the location of the request for payment.

5. The computer-implemented method of claim 1, wherein:
the first currency comprises a first fiat currency, and
the second currency comprises a second fiat currency different from the first fiat currency.

6-9. (canceled)

10. A computing device comprising:
one or more processors;
memory storing instructions that, when executed by the one or more processors, cause the computing device to:
receive, from a user device, a request to generate a mini-vault associated with a first account, wherein the request comprises:
a one-to-one affiliation between the mini-vault and one or more geographic restrictions on where the mini-vault can be accessed from, and
one or more time periods during which the mini-vault may be accessed;
generate, in response to the request to generate the mini-vault, the mini-vault;
generate, in response to generating the mini-vault, a pseudorandom number by hashing information associated with the first account and user information;
assign the pseudorandom number to the mini-vault as an account number;
provide, by the computing device and to the user device, information associated with the mini-vault;
monitor, by the computing device, an exchange rate between a first currency and a second currency;
determine the exchange rate between the first currency and the second currency;
transmit, to the user device, a request to purchase the second currency when the exchange rate is below a threshold, wherein the request to purchase the second currency is based on a future expense;
receive, from the user device, a response to the request to purchase the second currency, wherein the response comprises an approval to purchase the second currency;
purchase the second currency using funds from the first account based on receiving approval;
store the second currency in the mini-vault;
receive, from a merchant and via a secure communication channel, a request for payment in the second currency, wherein the request for payment comprises a payment amount and a location of the request for payment;
transmit, to the user device, a request to review the request for payment received from the merchant;
receive, from the user device, a response to the request to review the request for the payment, wherein the response comprises an approval of the payment amount to the merchant and a biometric identifier associated with a user of the user device;
verify that the location of the request for payment is within the geographic restrictions defined when the request to generate the mini-vault was received;
verify that the request for payment is within the one or more time periods during which the mini-vault may be accessed;
verify the biometric identifier by comparing the biometric identifier to a stored biometric identifier to authenticate the user; and
transmit, to the merchant via the secure communication channel and based on the received approval, a verification of the location of the request for payment, verification that the request for payment is within the one or more time periods, and verification of the biometric identifier, the payment amount from the mini-vault, wherein the mini-vault obfuscates information associated with the first account.

11. (canceled)

12. The computing device of claim 10, wherein the response further comprises a one-time password.

13. (canceled)

14. (canceled)

15. One or more non-transitory media storing instructions that, when executed by one or more processors, cause the one or more processors to perform steps comprising:
receiving, from a user device, a request to generate a mini-vault associated with a first account, wherein the request comprises:
a one-to-one affiliation between the mini-vault and one or more geographic restrictions on where the mini-vault can be accessed from, and
one or more time periods during which the mini-vault may be accessed;
generating, in response to the request to generate the mini-vault, the mini-vault;
generating, in response to generating the mini-vault, a pseudorandom number by hashing information associated with the first account and user information;
assigning the pseudorandom number to the mini-vault as an account number;
providing, to the user device, information associated with the mini-vault;
monitoring an exchange rate between a first currency and a second currency;
determining the exchange rate between the first currency and the second currency;
transmitting, to the user device, a request to purchase the second currency when the exchange rate is below a threshold, wherein the request to purchase the second currency is based on a future expense;
receiving, from the user device, a response to the request to purchase the second currency, wherein the response comprises an approval to purchase the second currency;
purchasing, based on the approval, the second currency using funds from the first account;
storing the second currency in the mini-vault;
receiving, from a merchant and via a secure communication channel, a request for payment in the second currency, wherein the request for payment comprises a payment amount and a location of the request for payment;
verifying that the location is within the one or more geographic restrictions defined when the request to generate the mini-vault was received;
verifying that the request for payment is within the one or more time periods during which the mini-vault may be accessed; and
transmitting, to the merchant, the payment amount from the mini-vault based on a verification that the location corresponds to the one or more geographic restrictions and based on verification that the request for payment is within the one or more time periods during which the mini-vault may be accessed.

16. The one or more non-transitory media of claim 15, further comprising instructions that cause the one or more processors to perform steps comprising:
denying the request for payment based on a determination that the location does not correspond with the geographic restrictions

17. The one or more non-transitory media of claim 15, further comprising:
sending, to the user device, a request to review the request for payment received from the merchant;
receiving, from the user device, a response to the request to review the request for the payment, wherein the response comprises an approval of the payment amount to the merchant and an authentication parameter, wherein the authentication parameter comprises a biometric identifier; and
verifying the authentication parameter provided in the response, wherein the transmitting the payment amount is further based on a verification of the authentication parameter.

18. The one or more non-transitory media of claim 15, further comprising:
sending, to the user device, a request to review the request for payment received from the merchant;
receiving, from the user device, a response to the request to review the request for the payment, wherein the response comprises an approval of the payment amount to the merchant and an authentication parameter, wherein the authentication parameter comprises a one-time password; and
verifying the authentication parameter provided in the response, wherein the transmitting the payment amount is further based on a verification of the authentication parameter.

19. (canceled)

20. (canceled)

21. The method of claim 1, wherein the user information comprises at least one of a social security number of the user, an address associated with the user, an age of the user, a credit score of the user, or an average account balance of the user.

22. The method of claim 1, wherein the providing information associated with the mini-vault comprises sending the information associated with the mini-vault via an encrypted channel.

23. The method of claim 1, wherein the transmitting the request to review the request for payment comprises at least one of: an email, a text message, a push notification, an electronic communication through a banking application, or an electronic communication via a web interface.

24. The method of claim 1, wherein the transmitting the request to review the request for payment comprises a request to activate a camera on the user device.

25. The method of claim 1, wherein the receiving the response to the request to review the request for the payment comprises a response via a mobile application.

26. The method of claim 1, wherein the biometric identifier comprises at least one of: an image of the user's face, a fingerprint, a voiceprint, or a retina scan.

27. The method of claim 1, wherein the receiving the response to the request to purchase the second currency comprises a response via a mobile application.

28. The method of claim 1 further comprising receiving a second request to generate a second mini-vault associated with the first account, wherein the second request comprises a one-to-one affiliation between the second mini-vault and a merchant.

29. The method of claim 28, wherein the second mini-vault maintains a zero balance until a time payment is to be remitted to the merchant.

30. The method of claim 28, further comprising sending a token to the merchant, wherein the token allows the merchant to withdraw an amount owed via the second mini-vault.
